(19) United States
(12) Patent Application Publication
(10) Pub. No.: US 2006/0053025 A1
(43) Pub. Date: Mar. 9, 2006

(54) Method of labeling and authenticating products

(76) Inventor: Richard Mertens, Laupheim (DE)

Correspondence Address: JANSSON, SHUPE, MUNGER & ANTARAMIAN, LTD, 245 MAIN STREET, RACINE, WI, 53403, US

(21) Appl. No.: 10/937,678

(22) Filed: Sep. 9, 2004

(51) Int. Cl. G06Q 99/00

(52) U.S. Cl. 705/1

(57) ABSTRACT

A method of labeling and authenticating a product, particularly a pharmaceutical package, for anti-counterfeiting purposes, the method comprising: generating original identification data referring to the product; encrypting the original data to generate encrypted identification data; storing the original data and the corresponding encrypted data in a database system; labeling the product with the encrypted data during a packaging process; and authenticating the product. The authentication of an product comprises: reading the encrypted data; transferring the encrypted data to a data processing system; decrypting the encrypted data in the data processing system to generate decrypted product identification data; comparing the decrypted data with the stored original data; determining whether the decrypted data matches the original data, thereby generating an authentication result; incrementing an authentication counter of the original data by one and storing the authentication counter; and, if the authentication result is positive and the authentication counter is less than or equal to a predetermined threshold, providing information that the product is genuine; or if the authentication result is positive and the authentication counter is above the predetermined threshold, providing information that the product is not genuine; or if the authentication result is negative, providing information that the product is not genuine.

### FIELD OF THE INVENTION

The invention relates to a method of labeling and authenticating products, particularly pharmaceutical packages, for anti-counterfeiting purposes.

### BACKGROUND OF THE INVENTION

The counterfeiting of consumer products is a common problem that governments and manufacturers around the world have to deal with. The counterfeiting of pharmaceuticals is an especially insidious practice. Counterfeiters of pharmaceutical products not only defraud consumers, they also deny ill patients the therapies that can alleviate suffering and save lives. In most countries, a comprehensive system of laws, regulations, and enforcement by authorities has kept the counterfeiting of medications to a minimum. In recent years, however, authorities have seen growing evidence of efforts by increasingly well organized counterfeiters backed by increasingly sophisticated technologies and criminal operations to profit from counterfeiting pharmaceuticals at the expense of all patients.

In order to respond to this emerging threat, the Food and Drug Administration of the United States has founded a counterfeit drug task force in July 2003 and issued a report “Combating Counterfeit Drugs” that was published in February 2004. In this report, the FDA has developed a comprehensive frame work for a pharmaceutical supply chain that will be secure against modem counterfeit threats.

A significant portion of the FDA report deals with the implementation of new technologies to better protect the supply of pharmaceuticals. Due to the fast growing capabilities of counterfeiters, there is no single “magic bullet” technology that provides any long term assurance of drug security. It is the intention of the FDA to facilitate the development of rapidly improving “track and trace” technologies and product authenticating technologies that will provide a much greater level of security for pharmaceutical products in the years to come.

In recent years modern technology has made some significant efforts and progresses and thus implemented a number of tracking and tracing as well as authenticating technologies in various industries, such as the mail and cargo transportion industries. However, in consumer product industries that manufacture very large numbers of individually packaged consumer products, such “track and trace” technologies are not yet available, as their implementation requires significant invetments at very high costs. A very promising approach appears to be radio frequency identification (RFID) which implies tagging of products by manufacturers, wholesalers, and retailers. Most importantly, reliable RFID technology will make the copying of pharmaceuticals either extremely difficult or unprofitable. However, readily available RFID technology systems do not yet exist. Experts like the FDA estimate that such RFID systems will only be fully tested and available by the year 2007, if not later.

### OBJECTS OF THE INVENTION

It is therefore the object of the present invention to overcome the aforementioned disadvantages and provide a method of labeling and authenticating products.

Another object of the invention is to provide such a method for use with pharmaceutical packages for anti-counterfeiting purposes, such method providing a secure end-to-end “track and trace” solution over the entire supply chain from pharmaceutical manufacturer over wholesalers to retailers or end customers.

### SUMMARY OF THE INVENTION

In certain embodiments, the method of labeling and authenticating products, particularly pharmaceutical packages, according to the invention comprises the following steps: generating original product identification data referring to an individual product, encrypting the original product identification data, thereby generating encrypted product identification data and storing the original product identification data and the corresponding encryption and decryption information in a database system, labeling the individual product with the encrypted product identification data during a packaging process, authenticating an individual product which comprises the steps of reading the encrypting product identification data from the individual product, transferring the encrypted product identification data to a data processing system, decrypting product identification data in the data processing system, thereby generating decrypted product identification data, comparing the decrypted product identification data with the stored original product identification data, determining whether the decrypted product identification data matches the original product identification data, thereby generating an authentication result, incrementing an authentication counter of the original product identification data by one and storing same, if the authentication result is positive, providing information that the individual product is a genuine product if the authentication result is positive and the authentication counter is less or equal to a predetermined threshold or that the individual product is not a genuine product if the authentication result is negative, or that the individual is not a genuine product if the authentication result is positive and the authentication counter is above a predetermined threshold.

The method in such embodiment ensures that an individual package of a pharmaceutical product is labeled with encrypted product identification data which is only known to the manufacturer of the pharmaceutical package, and allows for the authentication of an individual pharmaceutical packaged product at any time during or after the supply and sales processes.

In certain embodiments, the predetermined threshold in the authentication step preferably equals one. Through this limitation the manufacturer is enabled to set strict authentication conditions if required.

In a preferred embodiment of the method according to the invention the transfer of the encrypted product identification data is performed via a secured remote data connection. Since security plays the major role during the encryption process, the encryption data is only known to the manufacturer, it is important that all encryption information including all product identification data cannot get beyond the manufacturer's and/or packager's data systems.

In a further preferred embodiment of the method according to the invention the step of labeling the individual product with the encrypted product identification data is monitored by a control system and comprises the steps of detecting the specific property information of the individual product, and storing the recorded property information together with the original product identification data in the database system. Through these additional control steps the security measures of the entire method according to the invention are increased by adding additional property data to the original product identification data.

In another preferred embodiment of the method according to the invention, the step of authenticating the individual product further comprises the steps of providing an automated authentication program with a user interface, entering the encrypted product identification data into the user interface of said automated authentication program, and providing the user of said automated authentication program with the authentication result. Through the integration of modern internet-based real-time technologies the method according to the invention can be applied by any user who is provided with internet access at any time and at any location worldwide.

Preferably the method according to certain embodiments of the invention provides that the encryption information changes periodically. This feature adds additional security to the entire method and makes it more difficult for counterfeiters who try to imitate and overcome the encryption and authentication process.

Further details, features and advantages of the present invention emerge from the following description with reference made to the drawing.

### BRIEF DESCRIPTION OF THE DRAWINGS

FIG. 1 is flow chart illustrating embodiments of the invention..

### DETAILED DESCRIPTION OF PREFERRED EMBODIMENTS

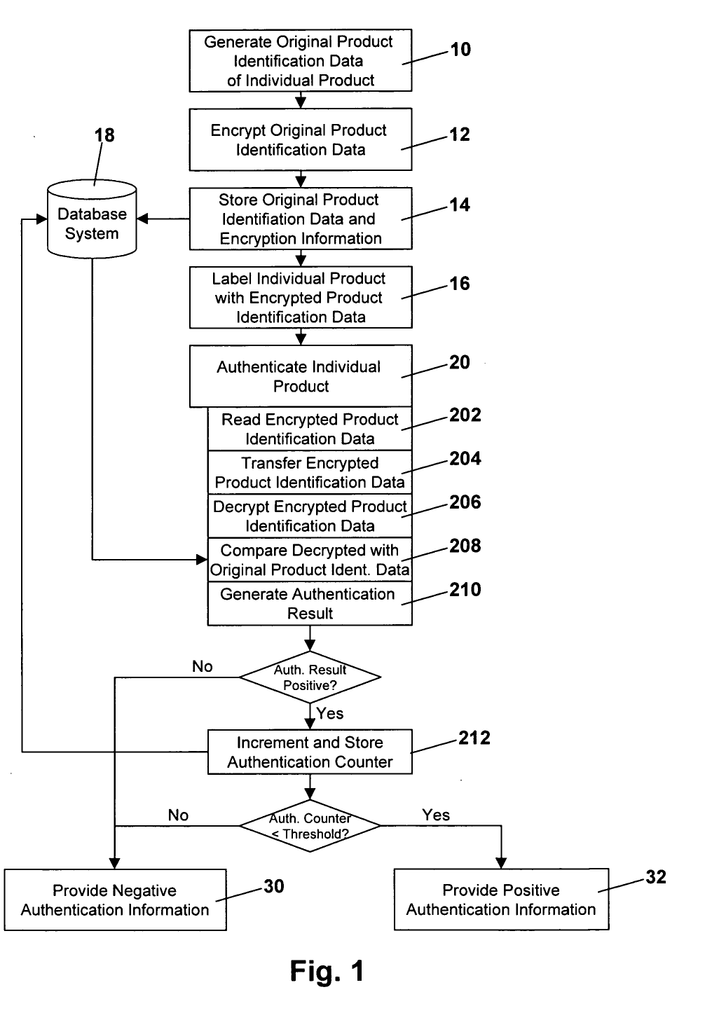

FIG. 1 shows a flow chart of the preferred embodiment of the method of labeling and authentication products according to the invention.

FIG. 1 shows a flow chart of the method of labeling and authenticating products according to the invention starting with the generation of original product identification data of an individual product, labeling with the numeral 10. In this step the manufacturer has to take into account, how many tablets, pills or other pharmaceutical products are to be manufactured and which type of package will be used for the respective product. For example, millions os aspirin tablets are manufactured daily and are packaged in blisters of ten tablets each, so that the original product identification data of the individual product “aspirin blister” containing ten tablets would consist of exactly one identifier.

The following process step 12 describes the encryption of the original identification data. This encryption is executed using modern encryption technologies that are known to the person skilled in the art. It is important to note that the encrypted original product identification data can only be interpreted by the manufacturer. It should also be noted that, from this point on, the only instance to make a link between the encrypted product identification data and the original product identification data is the manufacturer, for example the people employed in the manufacturer's data center.

Step 14 of FIG. 1 depicts the storage process of the original product identification data including the encryption information. All this information is stored in a database system 16 which usually also resides at the manufacturer's data center. With the storing of all this information the manufacturer is able to determine the original product identification data by decrypting the encrypted original product identification data according to the encryption information. The database system 16 can be any database system of modern information technology where online queries including several logical calculations can be executed within split seconds.

Step 18 of FIG. 1 depicts the labeling of an individual product with the encrypted product identification data. It is the first step where the encrypted product identification data has left the manufacturer's data center. At the packaging location, which can be a location of the manufacturer but also a location of a packager where the manufacturer has outsourced this particular service, digital printing devices may label the individual product which for example is a tablet blister, a plastic or glass bottle, a plastic film or lamination, or any other pharmaceutical package. After the packaging process each individual product is now labeled with the encrypted product data identification and ready to be shipped to wholesalers and retailers. It is labeled in such a way that the encrypted product identification data can easily be read without opening the individual package. Other labeling technologies, such as RFID, adhesion of preprinted tags etc. may also be considered.

As the next step FIG. 1 shows the step of authentication of an individual product. In this step 20 several sub-steps are included. In the following each of the sub-steps is described in detail.

The first sub-step 202 includes the reading of the encrypted product identification data that is present on the individual package. This reading step can be executed manually by a person or automatically by a scanning device or any other device that is able to read and to detect the encrypted product identification data. In one embodiment of the method according to the invention an end customer who has bought a pharmaceutical package at a drugstore or a pharmacy performs this step of reading with the intention to find out, whether his individual product package is a genuine product by the manufacturer as labeled on the package.

The following sub-step 204 describes the transfer of the encrypted product identification data to a data processing system. In the above example the end customer dials a toll-free service number of the manufacturer that is also printed on the product package, and submits the read encrypted product identification data to a service person who enters said encrypted product identification data into the data processing system. Other ways of transferring the read encrypted product identification data are naturally possible, e.g. remote connections via email, short message service and the like. Obviously, the encrypted product identification data does not have to be submitted to a service person; it is possible to transfer it directly into the secured data processing system of the manufacturer.

The nest sub-step of the authentication step 20 is the decryption of the encrypted product identification data 206. According to information that may be encoded into the encrypted product identification data, the data processing system can determine the necessary decryption key and decrypt the encrypted product identification data. Thereby decrypted product identification data is generated. After this sub-step the decrypted product identification data is compared with the original product identification data in sub-step 208. For this comparison sub-step a database query to the database system 16 is necessary. In the following sub-step 210 of the authentication step 20 an authentication result is generated. The authentication result is provided by determining whether the decrypted product identification data matches with the original product identification data. The sub-steps 206, 208 and 210 are executed by the data processing system which accesses the database system 16.

If the authentication result is positive, i.e. the decrypted product identification data matches one of the original product identification data sets in the database system, the data processing systems implements an authentication counter of the original product identification data by one and stores same with the original product identification data set in the database system 16. This sub-step is labeled with the numeral 212 in FIG. 1.

If the authentication result is negative, which means that there is no match between the decrypted product identification data and the stored product identification data, the data processing system provides a negative authentication information (step 30). This information is then forwarded to the requester. In the above example, the end customer is informed by the service person at the telephone, or in another embodiment of the invention via email or other electronic messaging systems.

To add additional security to the entire method of labeling and authentication products the authentication counter is checked by the data processing system. The intention of the authentication counter is to prevent counterfeiters from trying to authenticate a single pharmaceutical package that is a genuine product, and then label a huge number of counterfeit pharmaceutical product packages with the one encrypted product identification data that has proven to be genuine. If for example an end customer has bought a counterfeit pharmaceutical product with the already authenticated label, and has also requested the authentication of this product package at the manufacturer, the manufacturer can see that this particular encrypted product identification data has already been queried and provide a corresponding negative authentication result to the end customer. As a consequence all buyers of counterfeit packages that are labeled with the one particular encrypted product identification data, will receive a negative authentication response from the manufacturer when requesting this information via the method according to the invention.

The number of possible authentication requests for each original product identification data is determined by an authentication threshold that can be set individually for each pharmaceutical product. In the above example this authentication threshold has been set to one, which means that after exactly one authentication request has resulted in a positive authentication result, all subsequent authentication requests for the same encrypted product identification data will lead to a negative authentication information, because the stored authentication counter indicates that the encrypted product identification data has already been authenticated. Obviously the authentication threshold can be set individually depending on the pharmaceutical product, the number of instances in the supply chain or other criteria of anti-counterfeit measures.

Therefore, a positive authentication information (step 32) is only provided, if the authentication result is positive and the authentication counter is less than the authentication threshold.

Step 18 of the method of labeling and authenticating products can be further modified to add additional safety measures to the entire manufacturing process so that counterfeiters are faced with additional complexity. This step can comprise the steps of detecting and recording specific property information of the individual product, as well as storing the recorded property information together with the original product identification data in the database system. Cameras equipped with OCR (optical character recognition) systems that are known in the art monitor the labeling and/or packaging process. They detect and record specific properties of the packaged and labeled product such as optical properties like color, size, etc. Likewise, the chemical content of a fluid in a bottle or a tablet in a blister can be detected, for example by a NIR (near infra-red) measurement device. After these additional product identification data has been recorded, it is stored with the corresponding original product identification data in the database system 16.

In order to be able to read the additional property information of an individual product package (step 202) the authentication requester, e.g. a pharmacist, can implement a corresponding detection device and have it record as much product information as possible which is then transferred to the data processing system for authentication.

For the facilitation of an end customer using the method according to the invention, an automated authentication program, such as a java applet available at the manufacturer's internet web site, may be provided with a user interface, where the user can enter the encrypted product identification data, e.g. in an internet browser window. This automated authentication program is e.g. via a web server connected to the manufacturer's data center and is able to execute the corresponding processing steps. Obviously, extensive security measures have to be implemented for all publicly available data connections so that counterfeiters cannot circumvent or hack into the manufacturer's systems. The automated authentication program provides the user with the authentication result in the user interface (e.g. internet browser), if possible within split seconds.

While the principles of the invention have been shown and described in connection with specific embodiments, it is to be understood that such embodiments are by way of example and are not limiting.

1. A method of labeling and authenticating a product for anti-counterfeiting purposes, the method comprising:
generating original product identification data referring to the product;
encrypting the original data to generate encrypted product identification data;
storing the original data and the corresponding encrypted data in a database system;
labeling the product with the encrypted data during a packaging process; authenticating the product by:
reading the encrypted data;
transferring the encrypted data to a data processing system;
decrypting the encrypted data in the data processing system to generate decrypted product identification data;
comparing the decrypted data with the stored original data;
determining whether the decrypted data matches the original data, thereby generating an authentication result;
incrementing an authentication counter of the original data by one and storing the authentication counter; and
if the authentication result is positive and the authentication counter is less than or equal to a predetermined threshold, providing information that the product is genuine; or
if the authentication result is positive and the authentication counter is above the predetermined threshold, providing information that the product is not genuine; or
if the authentication result is negative, providing information that the product is not genuine.

2. The method of claim 1 wherein the predetermined threshold equals 1.

3. The method of claim 1 wherein the predetermined threshold equals 2.

4. The method of claim 1 wherein the transfer of the encrypted data is performed via a secured remote data connection.

5. The method of claim 1 wherein a control system monitors labeling of the product with the encrypted data, the method further comprising:
detecting and recording specific property information of the product; and
storing the recorded property information together with the original data in the database system.

6. The method of claim 5 wherein a NIR measurement device detects the specific property information of the product.

7. The method of claim 1 wherein authentication of the product further comprises:
providing an automated authentication program with a user interface;
entering the encrypted data into the user interface of the automated authentication program, and
providing a user of the automated program with the authentication result.

8. The method of claim 1 wherein the encryption information can be changed.

9. The method of claim 1 wherein digital printing devices are used to label the product.
